(19) United States
(12) Patent Application Publication
(10) Pub. No.: US 2007/0020550 A1
(43) Pub. Date: Jan. 25, 2007

(54) Toner for electrostatic image development and process for preparing the same

(75) Inventor: Takanori Kamoto, Yamatokoriyama-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/484,732

(22) Filed: Jul. 12, 2006

(30) Foreign Application Priority Data
Jul. 19, 2005 (JP) 2005-208556

(51) Int. Cl. G03G 9/087

(52) U.S. Cl. 430/109.4; 430/137.14

(57) ABSTRACT

A process for preparing a toner for electrostatic image development, the process comprising the steps of: (S1) mixing an aqueous pigment dispersion with an aqueous resin particle dispersion containing two or more kinds of self-dispersible polyester resin particles as binder resins to prepare a mixture; and (S2) adding a polyvalent metal salt as a flocculant to the mixture while stirring to form aggregates having the pigment bonded to the resin particles, wherein the self-dispersible polyester resins each are prepared by reacting a carboxylic acid compound with an alcohol compound inclusive of a polyhydric alcohol, and the carboxylic acid compound includes one or more kinds of a polycarboxylic acid having three or more carboxyl groups and its acid anhydride, the self-dispersible polyester resin particles are made from two or more kinds of self-dispersible polyesters having different glass transition temperatures, of which the lowest glass transition temperature is not lower than 40° C.

### CROSS-REFERENCE TO RELATED APPLICATION

This application is related to Japanese Patent Application No. 2005-208556 filed on Jul. 19, 2005 whose priority is claimed under 35 USC §119 and the disclosure of which is incorporated by reference in its entirety.

### BACKGROUND OF THE INVENTION

1. Field of the Invention

The present invention relates to a toner for electrostatic image development to be used with an electrophotographic image formation apparatus and a process for preparing the same. Furthermore, the present invention relates to an electrostatic image developer using the toner, and to an image formation method and formed image using the developer.

2. Description of the Related Art

Along with the recent remarkable advancement of OA appliances, copying machines, printers and facsimile apparatuses for carrying out printing by utilizing electrophotographic methods have become popular. Electrophotographic image formation apparatuses generally carry out image formation by charging, exposing, developing, transferring, cleaning, and fixing steps.

In the charging step, a surface of a photoconductor is evenly charged in a dark place. In the exposing step, an original image is projected onto the charged surface of the photoconductor to form an electrostatic latent image on the surface of the photoconductor by removing the electric charge of a portion where light is radiated. In the developing step, a toner image (a visible image) is formed by binding a toner to the electrostatic latent image formed on the surface of the photoconductor. In the transferring step, by bringing the toner image formed on the surface of the photoconductor into contact with a recording medium such as paper and a sheet and causing corona electric discharge from the side of the recording medium opposite to the side thereof on which the recording medium is in contact with the toner image to apply electric charge with polarity opposite to that of the toner to the recording medium, the toner image formed on the surface of the photoconductor is transferred to the recording medium. In the fixing step, the transferred toner image is fixed to the recording medium by heating or pressurizing means. In the cleaning step, a portion of the toner, not having been transferred to the recording medium and remaining on the surface of the photoconductor, is recovered. Electrophotographic image formation apparatuses form a desired image on a recording medium through the above-mentioned steps.

As a process for preparing of a toner for electrostatic image development to be used with an electrophotographic image formation apparatus, there may be mentioned a dry method and a wet method. A pulverization method can be exemplified as the dry method. The pulverization method is a method of obtaining a toner by melting and kneading a resin, a pigment (a coloring agent) and a wax, and pulverizing and classifying the obtained kneaded product by a pulverizer and has been employed widely in industrial fields. Desirably, toners have a small particle diameter so as to form high quality images. However, the pulverization method takes increased quantities of energy and time for pulverization, and toner preparation processes involving the pulverization method become complicated and lowers the yield and thus there has been a problem that the product cost considerably soars.

A suspension polymerization method and an emulsion polymerization method can be exemplified as the wet method. The suspension polymerization method is a method of obtaining a toner by suspension-polymerizing synthetic resin monomers such as vinyl monomers in an aqueous solvent containing a pigment.

On the other hand, the emulsion polymerization method is a method of obtaining a toner by mixing an aqueous dispersion of synthetic resin particles and a dispersion of a pigment dispersed in an organic solvent, forming agglomerated particles of the synthetic resin particles and the pigment, and heating and melting the agglomerated particles. As it is described in later, this method uses a surfactant in the resin particle dispersion serving as a starting substance for toner preparation and therefore the surfactant remains in the toner to be produced.

As another wet method, a method using phase inversion emulsification may be mentioned. This is a method of obtaining toner particles by dissolving or dispersing self-water dispersible resin and pigment in an organic solvent and adding water while adding and stirring a neutralization agent for neutralizing a dissociation group of the resin and thereby carrying out phase transfer emulsification of the resin solution droplets enclosing the pigment.

Also, there is another wet method of obtaining toner particles by dissolving or dispersing a resin in a solvent in which the resin is soluble, granulating the obtained solution or dispersion in a water medium containing an inorganic dispersant, removing the solvent, and drying the formed particles. This preparation process of a toner for electrostatic image development is a process for producing a toner by dissolving or dispersing materials containing a polyester resin and a pigment in a solvent in which the polyester resin is soluble, granulating the obtained solution in an aqueous medium containing an inorganic dispersant, and then removing the solvent.

The above-mentioned preparation of a toner by the wet method leaves an organic solvent, monomers of a resin, and a surfactant in the toner to be obtained. Such components bleed out of the toner at the time of practical use of the toner for development of an electrostatic latent image and cause damages to parts such as a development roller. Further, the chargeability of the toner becomes uneven. Accordingly, a step of removing the organic solvent, the monomers, and the surfactant from the toner is required after the toner is produced. However, the shape and the chargeability of the toner to be obtained tend to become uneven in accordance with slight fluctuation of operation conditions relevant to the pressure, temperature, and time in such a removal step. Therefore, to obtain a toner with a uniform shape, it is necessary to adjust the operation conditions to be optimum and it is very difficult to accomplish the adjustment. Further, since the organic solvent, the monomers, and the surfactant, which are heavy loads on ambient environments, are used in large quantities, the facilities to treat them are required, which raises the toner preparation costs. Further, in this emulsion polymerization method, monomers remain even in the toner. Therefore, there occurs a new problem that remaining monomers are evaporated and emit malodor when heat and pressure are applied to the toner for fixation or the like.

Further, the toners to be obtained by the above-mentioned conventional wet methods are not necessarily excellent in all the toner properties such as the image density and the image quality such as fogging, of the image to be formed on a recording medium by using the toners as well as the dispersibility of the pigment on the recording medium and the transfer ratio of the toner to the recording medium.

In order to overcome these defects, Japanese Unexamined Patent Publication No. Hei 10(1998)-39545 proposes a toner preparation process neither using any organic solvent nor involving any polymerization reaction at the time of preparation of toner particles. This toner preparation process comprises dispersing a pigment in water with use of a sodium sulfonated polyester, adding the aqueous pigment dispersion thus obtained to an emulsion obtained by dispersing sodium sulfonated polyester in water, and further adding an alkali halide solution, thereby forming agglomerates.

Further, Japanese Unexamined Patent Publication No. 2002-131977 discloses a toner preparation process that similarly uses a self-dispersible resin containing a hydrophilic ethylenic unsaturated monomer. In Japanese Unexamined Patent Publication No. 2002-131977, sodium sulfonate or potassium sulfonate of a styrene derivative is used as the hydrophilic ethylenic unsaturated monomer. The method of Japanese Unexamined Patent Publication No. 2002-131977 is a method of producing a toner using the self-dispersible resin containing a hydrophilic group of a sulfonic acid metal salt, which is a polyvalent metal salt, as a flocculant.

Also, Japanese Unexamined Patent Publication No. 2004-354411 and No. 2005-140855 disclose a toner preparation process using a mixture of a vinyl type resin dispersion and a self-dispersible polyester. These documents describe that the self-dispersible polyester is preferably a polyester resin containing no trivalent monomer. Also, they describe that an ionic surfactant is used as a flocculant for causing soft flocculation.

Desirably, toners for electrostatic image development do not contain unnecessary components such as an organic solvent or monomers; are capable of being produced easily; and have excellent toner properties.

With respect to the toner preparation process of Japanese Unexamined Patent Publication No. Hei 10(1998)-39545, a toner composition is produced by flocculating a pigment dispersed in water with use of a sodium sulfonated polyester and a sodium sulfonated polyester dispersed in water. Thus this process permits preparation of a toner composition free from unnecessary components such as an organic solvent and monomers. In this process, however, since the pigment is dispersed by using only the sodium sulfonate polyester, the dispersibility of the pigment is so insufficient as to cause formation of aggregates solely of the pigment and thus render the toner property such as a color reproducibility unsatisfactory. Thus, this process is unsuitable for production of a toner having excellent toner properties. Further, the toner produced by the method is unstable in the chargeability depending on environmental conditions and there is a problem that its use is limited in accordance with the environmental conditions. It is supposed that the problem is attributed to the sulfonic acid group, which is a hydrophilic group.

Similarly, also in the toner preparation process disclosed in Japanese Unexamined Patent Publication No. 2002-131977, the pigment dispersibility is maintained, although the properties, of a toner to be produced, related to the environmental conditions involves a similar problem to that mentioned above because the hydrophilic group is a sulfonic acid metal salt.

Further, with respect to toners respectively disclosed in Japanese Unexamined Patent Publication No. 2004-354411 and No. 2005-140855, they are produced using the mixture of the self-dispersible polyester and the vinyl type resin. Though the vinyl type resin is used as mentioned above, the toners contain a monomer. Also, since soft flocculation is caused due to the use of the surfactant, it is very difficult to control the toner particle diameter.

### SUMMARY OF THE INVENITION

In one aspect, the present invention provides a process for preparing a toner for electrostatic image development, the process comprising the steps of: (S1) mixing an aqueous pigment dispersion with an aqueous resin particle dispersion containing two or more kinds of self-dispersible polyester resin particles as binder resins to prepare the mixture; and (S2) adding a polyvalent metal salt as a flocculant to the mixture while stirring to form aggregates having the pigment bonded to the resin particles, wherein the self-dispersible polyester resins each are prepared by reacting a carboxylic acid compound with an alcohol compound inclusive of a polyhydric alcohol, and the carboxylic acid compound includes one or more kinds of a polycarboxylic acid having three or more carboxyl groups and its acid anhydride, the self-dispersible polyester resin particles are made from two or more kinds of self-dispersible polyesters having different glass transition temperatures, of which the lowest glass transition temperature is not lower than 40° C.

In another aspect, the present invention provides a toner for electrostatic image development prepared by the above-mentioned process.

In another aspect, the present invention provides an electrostatic image developer containing (1) the above-mentioned toner and (2) a carrier.

In still another aspect, the present invention provides an image formation method comprising the steps of: forming an electrostatic latent image on a photoconductor; forming a toner image by developing the electrostatic latent image on the photoconductor using the above-mentioned electrostatic image developer; and transferring and fixing the toner image onto a recording medium.

In yet another aspect, the present invention provides an image formed by the above-mentioned image formation method.

The process for preparing a toner for electrostatic image development of the present invention comprises (1) mixing together at least an aqueous pigment dispersion containing a pigment and an aqueous resin particle dispersion containing self-dispersible polyester resin particles and (2) adding an aqueous solution containing a flocculant to the mixture while stirring to form aggregates having the pigment bonded to particles of the self-dispersible polyester resins. According to the process of the present invention, it is possible to easily produce a toner substantially free of unnecessary components such as a dispersant used for emulsifying and dispersing resins, an organic solvent and binder-resin-composing monomers, which are required in conventional methods. In conventional methods involving the step of melting and kneading a pigment and a binder resin, shear stress applied at the kneading could cut the molecular structure of the binding resin and change the molecular weight distribution thereof to make it impossible to obtain a toner with desired toner properties. In the present invention, on the other hand, such a problem will not occur.

Further, according to the process of the present invention, due to the use of the self-dispersible polyester resins with different glass transition temperatures (with different number average molecular weights), it is possible to produce a toner improved in toner properties, particularly fixation property.

Also, if a pigment with excellent dispersibility is used, it is possible to control the particle diameter of the pigment dispersed in the toner to be small and to produce the toner excellent in the toner properties such as color reproducibility.

Further, the toner for electrostatic image development according to the present invention, which is produced by the above-mentioned process, contains a reduced amount of unnecessary components such as an organic solvent and binder-resin-composing monomers and the toner is excellent in the toner properties.

Also, since the toner for electrostatic image development according to the present invention contains carboxylic acid having a hydrophilic group, by washing with an acid, the toner can be made hydrophobic and excellent in environmental stability as compared with a polyester resin containing a sulfonic acid group.

### BRIEF DESCRIPTION OF THE DRAWING

FIG. 1 is a flow chart showing a preparation process of a toner for electrostatic image development according to the present invention.

### DESCRIPTION OF THE PREFERRED EMBODIMENTS

The present invention provides a process for preparing a toner for electrostatic image development, comprising the steps of: (S1) mixing an aqueous pigment dispersion with an aqueous resin particle dispersion containing two or more kinds of self-dispersible polyester resin particles as binder resins to prepare a mixture; and (S2) adding a polyvalent metal salt as a flocculant to the mixture while stirring to form aggregates having the pigment bonded to the resin particles, wherein the self-dispersible polyester resins each are prepared by reacting a carboxylic acid compound with an alcohol compound inclusive of a polyhydric alcohol, and the carboxylic acid compound includes one or more kinds of a polycarboxylic acid having three or more carboxyl groups and its acid anhydride, the self-dispersible polyester resin particles are made from two or more kinds of self-dispersible polyesters having different glass transition temperatures, of which the lowest glass transition temperature is not lower than 40° C.

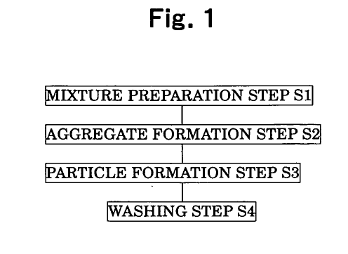

FIG. 1 is a flow chart showing the process for preparing a toner for electrostatic image development according to the present invention. In the toner preparation process according to the preferred embodiments of the present invention, the mixture preparation step S1, the aggregate formation step S2, a particle formation step S3, and a washing step S4 are carried out in this order.

In the mixture preparation step S1, toner components such as a pigment, self-dispersion type binder resins (hereinafter, also referred to as binder resins or simply as resins) and the like are mixed with water to produce the mixture. In the aggregate formation step S2, an aqueous solution containing a flocculant is added to the above-mentioned mixture to form a toner in form of aggregates in the aqueous medium. Further, the particle formation step S3 and the washing step S4 are carried out to obtain a toner excellent in the toner properties. More specifically, in the particle formation step S3, the aqueous medium containing the aggregates is heated to granulate the aggregates. In the washing step S4, the granulated aggregates are washed and dried.

Hereinafter the above-mentioned respective steps will be described in more detail.

(Mixture Preparation Step S1)

In the mixture preparation step S1, a pigment and self-dispersion type binder resins, which will be described later, are separately dispersed in water by a stirrer (an emulsifier or a dispersing apparatus) to respectively produce an aqueous pigment dispersion containing the pigment and an aqueous resin particle dispersion containing the self-dispersion type binder resin particles (hereinafter, also referred to as binder resin particles). Then, the aqueous pigment dispersion and the aqueous resin particle dispersion are mixed together and stirred to produce a mixture containing the toner components. Preferably, the aqueous resin particle dispersion and the aqueous pigment dispersion are mixed together so that the mixture contains 80 to 99% by weight of the binder resins on the basis of the solid matter concentration and 0.1 to 20% by weight of the pigment, and then the mixture is stirred at a room temperature for 1 to 5 hours by a stirrer. Further, in the mixture preparation step S1, an aqueous wax fine particle dispersion containing natural and/or synthesized wax fine particles emulsified in water may be added in the above-mentioned mixture. The amount of the aqueous wax fine particle dispersion to be added is about 0.1 to 20% by weight on the basis of the solid matter concentration.

(Aggregate Formation Step S2)

In the aggregate formation step S2, aggregates containing the toner components are formed by adding, to the mixture containing the toner components such as the pigment and the binder resins (in some cases, also containing wax fine particles as a toner component), a flocculant in a prescribed amount, for example, in 0.5 to 20 parts by weight with respect to 100 parts by weight of the toner components of the mixture. Accordingly, unnecessary components other than the toner components, for example, an organic solvent, and monomers that constitute the binder resins are not contained in the toner.

This step S2 is preferably carried out at room temperature, but may be carried out with heating to a temperature near the lowest glass transition temperature of the glass transition temperatures of the binder resins. Further, in the step S2, it is preferable to stir the mixture by mechanical shear force by a stirrer in order to easily obtain aggregates in form of particles with uniform particle diameter and shape.

In this aggregate formation step S2, a prescribed amount (e.g. 1 to 5% by weight with respect to the total amount of the resins used) of an aqueous binder resin particle dispersion containing a binder resin but not any pigment may further be added. In this case, the total amount of the resins in the aqueous binder resin particle dispersion to be added in the mixture preparation step S1 is desirably decreased by a prescribed amount. Further, to prevent re-flocculation of the aggregates, a surfactant may be added or sodium hydroxide for adjusting the pH to 8 or higher may be added.

(Particle Formation Step S3)

In the particle formation step S3, the water medium containing the obtained aggregates is heated to form the aggregates into particles with approximately uniform particle diameter and shape. In this case, it is preferable to carry out the heating to the highest glass transition temperature or to a temperature higher than the highest glass transition temperature of the glass transition temperatures of the two or more binder resins with different glass transition temperatures so as to adjust the particle diameter to 1 to 20 μm. In such a manner, toner particles with approximately uniform particle diameter and shape can be obtained.

Further, in the particle formation step S3, an aqueous binder resin particle dispersion containing a binder resin for controlling the toner shape may further be added to again form aggregates. In this case, to prevent re-flocculation of the aggregates, a surfactant may be added or sodium hydroxide for adjusting the pH to 8 or higher may be added. In this case as well, it is desirable to decrease by a prescribed amount the total amount of the resins of the aqueous binder resin particle dispersion to be added in the previous mixture preparation step S1.

(Washing Step S4)

In the washing step S4, the mixture containing the toner (aggregates) is cooled to, for example, room temperature and filtered to remove the supernatant solution and the separated toner is washed with water. For the washing, it is preferable to use water having a conductivity of 20 μS/cm or lower (preferably 10 μS/cm or lower) and it is also preferable to wash the toner until the supernatant solution of the washing water used for the washing of the toner has a conductivity of 50 μS/cm or lower. The washing of the toner with water may be carried out in batches or continuously. The washing of the toner with water is carried out for removing unnecessary components such as impurities which may affect the chargeability of the toner and unneeded flocculant which has not been involved in the flocculation, other than the toner components and accordingly the toner free of unnecessary components can easily be produced. During the step of washing with water, a step of washing with water at pH 6 or lower may be carried out at least once and accordingly impurities can be removed more sufficiently. After that, the toner washed in such a manner is separated from the washing water by filtration and may be dried by a vacuum drying apparatus. Additionally, desirable additive(s) (e.g. a charge controlling agent, a release agent, and an extrapolating agent) may be added to the toner after the drying.

[Description of Toner Components]

(Self-Dispersion Type Binder Resin Particles)

In the present invention, the self-dispersion type binder resins are not particularly limited if these resins can be dispersed and kept in dispersed state in water and if these resins have different glass transition temperatures. The self-dispersion type binder resins may be conventionally known resins such as polyester resins, vinyl type copolymer resins, polyurethane resins, and epoxy resins. Of these, two or more of different kinds may be used as the self-dispersion type binder resins.

Additionally, two or more of the same kind of the above-mentioned resins may be used as the self-dispersion type binder resins if they are different from one another in one or more of the number average molecular weight, the monomer composition and the like. Furthermore, the self-dispersion type binder resins may be a resin mixture containing, as binder resins, 50% by weight or higher of at least two resins selected from the exemplified polyester resins, vinyl type copolymer resins, polyurethane resins and epoxy resins and as the balance, less than 50% by weight of one or more synthetic resins fusible by heating, other than the exemplified resins. In this case, all the resins to be used are preferably synthetic resins having compatibility and fusible by heating. The binder resins more preferably contain hydroxyl group in their main chain.

With respect to the binder resins having different glass transition temperatures to be used in the present invention, the lowest glass transition temperature is preferably not lower than 40° C., more preferably not lower than 45° C., and even more preferably about 50° C. Also, in the case where the glass transition temperatures are set in the above range, the toner properties, particularly the toner fixation property is excellent. If the lowest glass transition temperature is lower than 40° C., the storage property, the fixation property and the durability tend to be lowered.

In consideration of improvements in the powder fluidity, the lower temperature fixation property and the secondary color reproducibility of toner particles to be obtained, preferable examples of the binder resins to be used in the present invention include polyester resins and vinyl type copolymer resins, among which a resin containing a polyester resin as a main component is more preferable. In the case where the resin containing a polyester resin as a main component is employed, the ratio of the polyester resin to all the binder resins is preferably 50% by weight or higher, more preferably 80% by weight or higher, and even more preferably 90% by weight or higher in terms of improvements in the reproducibility of the color of the toner and the adhesive strength of the toner to paper or the like. Hereinafter, the polyester resin will be described.

The polyester resin is obtained by condensation polymerization of an acid component and an alcohol component. Preferably, it is obtained by condensation polymerization of an acid component composed mainly of polyfunctional carboxylic acids and an alcohol component composed mainly of polyhydric alcohols.

Examples of the above-mentioned polyfunctional carboxylic acids are aromatic dicarboxylic acids such as terephthalic acid, isophthalic acid, o-phthalic acid, 1,5-naphthalenedicarboxylic acid, 2,6-naphthalenedicarboxylic acid, anthracenedipropionic acid, anthracenedicarboxylic acid, diphenic acid, sulfoterephthalic acid, 5-sulfoisophthalic acid, 4-sulfophthalic acid, 4-sulfonaphthalene-2,7-dicarboxylic acid, 5(4-sulfophenoxy)isophthalic acid, and their metal salts and ammonium salts; aromatic oxycarboxylic acids such as p-oxybenzoic acid and p-(hydroxyethoxy)benzoic acid; aliphatic dicarboxylic acids such as succinic acid, adipic acid, azelaic acid, sebacic acid, and dodecanedicarboxylic acid; aliphatic unsaturated polyfunctional carboxylic acids such as fumaric acid, maleic acid, itaconic acid, mesaconic acid, and citraconic acid; aromatic unsaturated polyfunctional carboxylic acids such as phenylenediacrylic acid; alicyclic dicarboxylic acids such as hexahydrophthalic acid and tetrahydrophthalic acid; and tri- or higher polyfunctional carboxylic acid such as trimellitic acid, trimesic acid, and pyromellitic acid and/or their acid anhydrides. These may be used alone or in combination of two or more.

In the present invention, the above-mentioned acid component may contain monocarboxylic acids. Preferable as the monocarboxylic acids are aromatic monocarboxylic acids. Examples of the aromatic monocarboxylic acids are benzoic acid, chlorobenzoic acid, bromobenzoic acid, p-hydroxybenzoic acid, naphthalenecarboxylic acid, anthracenecarboxylic acid, 4-methylbenzoic acid, 3-methylbenzoic acid, salicylic acid, thiosalicylic acid, phenylacetic acid, their lower alkyl esters, sulfobenzoic acid monoammonium salt, sulfobenzoic acid monosodium salt, cyclohexylaminocarbonylbenzoic acid, n-dodecylaminocarbonylbenzoic acid, tert-butylbenzoic acid, and tert-butylnaphthalenecarboxylic acid.

In the above-mentioned acid component, the content of the polyfunctional carboxylic acids is 70% by mole or higher, preferably 80% by mole or higher, and more preferably 90% by mole or higher. Aromatic polyfunctional carboxylic acids are preferable as the polyfunctional carboxylic acids. Further, the aromatic polyfunctional carboxylic acids preferably contain terephthalic acid and isophthalic acid. The content of terephthalic acid is preferably 40 to 95% by mole, more preferably 60 to 95% by mole, and even more preferably 70 to 90% by mole in the acid component. The content of isophthalic acid is preferably 5 to 60% by mole in the acid component. Further, the total content of terephthalic acid and isophthalic acid is preferably 80% by mole or higher and more preferably 90% by mole or higher in the acid component. In the present invention, preferable examples of the polyfunctional carboxylic acids include tri- or higher polyfunctional carboxylic acids such as trimellitic acid, trimesic acid and pyromellitic acid, and acid anhydrides of these polyfunctional carboxylic acids such as pyromellitic acid anhydride, cyclohexane-1,2,3,4-tetracarboxylic acid-3,4-dihydride, ethylene glycol bisanhydrotrimellitate. These may be contained alone or in combination of two or more, and the content of the polyfunctional carboxylic acids is preferably 0.5 to 30% by mole and particularly preferably 0.5 to 20% by mole in the acid component. When the monocarboxylic acids are contained in the acid component, the content of the monocarboxylic acids is preferably 2 to 25% by mole, more preferably 5 to 20% by weight. The reason for that is because the self-dispersibility of the polyester resins can be retained.

In the present invention, examples of the above-mentioned polyhydric alcohols include aliphatic polyhydric alcohols, alicyclic polyhydric alcohols, and aromatic polyhydric alcohols. Examples of the aliphatic polyhydric alcohols are aliphatic diols such as ethylene glycol, propylene glycol, 1,3-propane diol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol and polytetramethylene glycol; and triols and tetraols such as trimethylol ethane, trimethylol propane, glycerin, and pentaerythritol. Examples of the alicyclic polyhydric alcohols are 1,4-cyclohexanediol, 1,4-cyclohexanedimethanol, spiroglycol, hydrated bisphenol A, hydrated bisphenol A ethylene oxide adduct and propylene oxide adduct, tricyclododecanediol, and tricyclodecanedimethanol. Examples of the aromatic polyhydric alcohols are p-xylene glycol, m-xylene glycol, o-xylene glycol, 1,4-phenylene glycol, 1,4-phenylene glycol ethylene oxide adduct, bisphenol A, ethylene oxide adduct and propylene oxide adduct of bisphenol A. Also, examples of the polyester polyols are lactone type polyester polyols obtained by ring opening polymerization of lactones such as ε-caprolactone.

In the present invention, as the alcohol component, the polyhydric alcohols may contain monoalcohols. Examples of the monoalcohols are aliphatic alcohols, aromatic alcohols, and alicyclic alcohols.

In the alcohol component composing the polyester resin of the present invention, the content of the polyhydric alcohols is 50% by mole or higher, preferably 70% by mole or higher, more preferably 80% by mole or higher, and even more preferably 90% by mole or higher. Aliphatic diols and/or alicyclic diols are preferably contained as the polyhydric alcohols. Preferable examples of the aliphatic diols are ethylene glycol, propylene glycol and 2,3-butanediol. Among them, ethylene glycol and propylene glycol are more preferable. Preferable examples of the alicyclic diols are tricyclodecanedimethanol, cyclohexanediol, and cyclohexanedimethanol. Particularly, in the present invention, ethylene glycol and/or propylene glycol are contained in an amount of 50% by mole or higher, preferably 60% by mole or higher, and more preferably 70% by mole in the alcohol component.

As described above, the polyester resin is obtained by condensation polymerization of di- or higher polyfunctional carboxylic acids and di- or higher polyhydric alcohols as raw materials, and the purpose of the condensation polymerization using the raw materials is to widen the molecular weight distribution of the polyester resin but not to gel the resin. Gelation of the resin makes it difficult to take the resin out of a polymerization apparatus and considerably lowers the productivity. The polyester resin to be used in the present invention is substantially free from gelation and more specifically, the polyester resin has the content of a chloroform-insoluble component of not higher than 0.5% by weight and preferably not higher than 0.25% by weight and an acid value of 40 mgKOH/g or lower and preferably 30 mgKOH/g or lower.

In the present invention, the glass transition temperature (or the softening point) of the polyester resin is preferably 40 to 80° C. (80 to 150° C.), more preferably 45 to 80° C. (85 to 150° C.), and even more preferably 50 to 75° C. (80 to 145° C.). In the case where the polyester resin has a glass transition temperature lower than 40° C. and a softening temperature lower than 80° C., the toner obtained by using the polyester resin tends to cause blocking and has a problem in the storability. On the other hand, if the polyester resin has a glass transition temperature exceeding 80° C., the toner tends to cause off-set and, particularly in the case of color printing by overlaying colors, this problem tends to become significant. If the polyester resin has a softening point exceeding 150° C., the toner obtained by using the polyester resin has a problem in the fixation property and requires that a fixation roll be heated to a high temperature and therefore, the material for the fixation roll and the material for a substrate of a transfer medium are limited.

In the present invention, in which the polyester resin has a glass transition temperature and a softening temperature in the above ranges, there is a wide choice of molecular weights of the polyester resin. In view of the use as a color toner of the toner obtained; improvement in the fixation of the toner on a OHP sheet; and prevention of a failure of the toner to be fixed on the transfer medium caused by shifting offset area to high temperature side, however, the molecular weight of the polyester resin is preferably 2000 to 200000, more preferably 2000 to 50000, and the number average molecular weight of the polyester resin is 2000 to 30000, preferably 3000 to 25000, more preferably 3000 to 20000. In the case where the polyester resin has a number average molecular weight of greater than 200000, the polyester resin hardly self-disperses. In the case where the polyester resin has a number average molecular weight of smaller than 2000, the toner obtained has a poor durability.

The hydrophilic groups contained in the main chains of the binder resins are preferably ionic groups and among them, anionic groups are particularly preferable. Specifically preferable examples of the hydrophilic groups are carboxyl group, sulfonic acid group, phosphoric acid group, phosphonic acid group, phosphinic acid group, ammonium salts and metal salts of these groups and among them, carboxylic acid alkali metal salts, carboxylic acid ammonium salts, sulfonic acid alkali metal salts and sulfonic acid ammonium salts are more preferable. In the case where polyester resins are used, for introduction of carboxylic acid alkali metal salts and carboxylic acid ammonium salts, a method can be used which involves steps of-introducing polyfunctional carboxylic acids as exemplified above such as trimellitic acid and/or their acid anhydrides in a reaction system in the terminal period of polyester polymerization to add carboxyl groups to the polymer terminals and/or molecular chains and neutralizing the carboxylic acids and/or their acid anhydrides with ammonia or sodium hydroxide to convert them to carboxylic acids. The ionic groups provide water-dispersibility to the polyester resins and at the time of polymerization for producing the polyesters, the counter cation of the ionic group-containing monomers is preferably mono-valent cation. The self-dispersion type polyester resins having the carboxylic acid salts as hydrophilic groups have an advantage that they can be made hydrophobic by a washing step to be carried out thereafter.

Next, a method of obtaining particles having a prescribed average particle diameter and particle diameter distribution from the self-dispersion type binder resins having ionic groups will be described. Ionic group-containing polyester resins have water-dispersibility. An aqueous micro-dispersion of an ionic group-containing polyester resin can be produced by a conventionally known method. For example, there is a method of producing it by heating an ionic group-containing polyester resin and a water-soluble organic compound to 50 to 200° C., mixing them, and then adding water to the mixture.

There is also another method of producing it by adding a mixture of an ionic group-containing polyester resin and a water-soluble organic compound (e.g. a compound to be a counter cation) to water, heating the obtained mixture at 40 to 120° C., and thereby dispersing the resin and the compound.

Further, there is another method of producing it by adding an ionic group-containing polyester resin to a mixture of water and a water-soluble organic compound, heating the obtained mixture at 40 to 100° C., and stirring the mixture.

Examples of the above-mentioned water-soluble organic compound are solvents such as ethanol, butanol, isopropanol, ethyl cellosolve, butyl cellosolve, dioxane, tetrahydrofuran, acetone, and methyl ethyl ketone.

The average particle diameter of the binder resin particles such as the aqueous micro-dispersion of the polyester resin is 0.2 μm or smaller, preferably 0.01 to 0.15 μm, and more preferably 0.01 to 0.1 μm. If the average particle diameter of the binder resin particles is larger than 0.2 μm, the flocculated particles become so large that control of them properly to the toner size might be difficult.

(Pigment)

In the present invention, conventionally know pigments can be used and pigments such as blue, brown, cyan, green, violet, magenta, red and yellow pigments can be used and their mixtures are also usable. More specific examples of the pigment(s) of the present invention include anthraquinone type pigments, phthalocyanine blue type pigments, phthalocyanine green type pigments, diazo type pigments, monoazo type pigments, pyranthrone type pigments, perylene type pigments, heterocyclic yellow, quinacridone, indigoid type pigments, and thioindigoid type pigments. Examples of the anthraquinone type pigments may be Pigment red 43, Pigment red 194 (Perinone red), Pigment red 216 (brominated Pyranthrone red), and Pigment red 226 (Pyranthrone red). Examples of the phthalocyanine blue type pigments are copper phthalocyanine glue and its derivative, Pigment blue 15. Examples of the perylene type pigments are Pigment red 123 (Vermillion), Pigment red 149 (Scarlet), Pigment red 179 (Maroon), Pigment red 190 (Red), Pigment violet, Pigment red 189 (Yellow shade red), and Pigment red 224. Examples of the heterocyclic yellow type pigments are Pigment yellow 117 and Pigment yellow 138. Examples of quinacridone type pigments are Pigment orange 48, Pigment orange 49, Pigment red 122, Pigment red 192, Pigment red 202, Pigment red 206, Pigment red 207, Pigment red 209, Pigment violet 19 and Pigment violet 42. Examples of the thioindigoid type pigments are Pigment red 86, Pigment red 87, Pigment red 88, Pigment red 181, Pigment red 198, Pigment violet 36, and Pigment red 38. Carbon black to be produced by various methods can be used as a black color pigment.

The above-mentioned pigments may be dispersed in water by using a dispersant such as a surfactant. In this case, as the dispersant, anionic surfactants and nonionic surfactants are preferably used. Among these, more preferable are anionic surfactants. Use of the dispersant makes it easy for the pigments to be dispersed in water, makes the dispersion diameter of the pigments in a toner small, and makes it possible to produce a toner with excellent toner properties. Further, an unnecessary dispersant can be removed by the washing step.

The aforementioned pigments may be used alone or in combination of two or more. Further, in the case where two or more of pigments are used in combination, pigments of the same color type may be used in combination or pigments of different color types may be used in combination. There is a wide choice of contents of the pigment(s) determined in accordance with the required toner properties in the present invention, and the content of the pigment(s) is preferably 0.1 to 20% by weight and more preferably 0.1 to 15% by weight with respect to 100% by weight of the binder resin. If the content of the pigment(s) is lower than 0.1% by weight, it is difficult to obtain images with high image density and if the content of the pigment(s) exceeds 20% by weight, it is difficult to secure the dispersibility of the pigment(s) in the images to be formed.

(Wax Fine Particles)

In the present invention, wax fine particles may be added as a toner component. Conventionally known waxes can be used as the fine particles and for example, natural waxes such as carnauba wax and rice wax; synthetic waxes such as polypropylene wax, polyethylene wax, and Fischer-Tropsch wax; coal waxes such as montan wax; alcohol type waxes; and ester type waxes may be mentioned. These waxes may be used alone or in combination of two or more. The wax fine particles are added to the mixture in the mixture preparation step S1. Preferably, the wax fine particles are added either as an aqueous wax fine particle dispersion previously produced by mixing and emulsifying a wax in water or as an encapsulated wax obtained by encapsulating the surface of the wax with a resin to the mixture. This is because if the wax fine particles are added as the encapsulated wax, the wax is not exposed to the toner particle surface on which no resin layer is provided and therefore the spent of wax to the carrier can be improved. In the case where the wax fine particles is added as a toner component, the content of the wax fine particles is preferably 0.5 to 20% by weight and more preferably 1 to 10% by weight with respect to 100% by weight of the binder resin.

(Additives)

In the present invention, besides the above-mentioned toner components, upon the necessity, proper amount(s) of additive(s) to be commonly added to a toner, such as a charge controlling agent and a release agent, may be added to the toner dried after the washing step.

Further, conventionally known extrapolating agent(s) may be added to the toner dried after the washing step to reform the surface of the toner particles. Examples of the conventionally known extrapolating agents include inorganic particles dispersible in water such as silica and titanium oxide. These inorganic particles have an average particle diameter of 1 μm or smaller, preferably 0.01 to 0.8 μm and may be used in combination of two or more. Further, a silicone resin may be added to the extrapolating agents to reform the surface. The addition amount of the extrapolating agents is preferably 1 to 10 parts by weight with respect to 100 parts by weight of the toner particles.

The toner to be obtained by the above-mentioned process of the present invention has preferably an average particle diameter of 10 μm or smaller, more preferably 2 to 9 μm, and even more preferably 3 to 8 μm. If the average particle diameter of the toner exceeds 10 μm, the particle size distribution becomes broad and dispersion of the chargeability becomes wide, in relation to the toner preparation process, and the widened dispersion of the chargeability causes image disorder.

The toner to be obtained by the above-mentioned process of the present invention may be used as a one-component type developer or as a component of a two-component type developer. In the case where the toner is used as a one-component type developer, the toner is used alone and no carrier is used and image formation is carried out by generating friction charge on a developer sleeve using a blade and a fur brush and thereby sticking and transferring the toner on the sleeve.

On the other hand, in the case the toner is used as a component of a two-component type developer, the toner is used in combination with a carrier. Conventionally known carriers may be used as the carrier and for example, carriers made of single elements such as iron, copper, zinc, nickel, cobalt, manganese, magnesium, and chromium, and composite ferrites can be used. Also, the carrier may have a surface coated with material(s) (hereafter, referred to as coating material(s)). Examples of the coating material(s) include conventionally known materials such as polytetrafluoroethylene, monochlorotrifluoroethylene polymers, poly(vinylidene fluoride), silicone resins, polyester resins, di-tert-butylsalicylic acid metal compounds, styrene type resins, acrylic resins, polyacids, polyvinyl-ral, Nigrosine, amino acrylate resin, basic dyes, lakes of basic dyes, silica fine powder, and alumina fine powder. The choice of which coating material(s) to use is preferably made in accordance with the toner components. A single coating material or a combination of two or more coating materials may be used. The average particle diameter of the carrier is preferably 10 to 100 μm and more preferably 20 to 80 μm.

[Explanation of Flocculant]

Conventionally known flocculants may be used as the flocculant to be used in the aggregate formation step in the toner preparation process of the present invention and for example, electrolytic substances and organic compounds having ion polarity opposite to that of the pigment can be used. As described above, since the binder resin and the pigment preferably have ionic groups and/or ionizable groups in their surfaces, polyvalent metal salts capable of forming ion bonds with such a binder resin and pigment are preferable. Further, magnesium sulfate and aluminum sulfate, which are easily dissolvable in water, are more preferable since they can easily be washed with water. Between them, magnesium sulfate is particularly preferable. This is because the valance of the ion of the magnesium salt is di-valence, and in the case where it is used as a flocculant, the flocculation speed is more moderate than in the case where the aluminum salt having tri-valence is used as a flocculant and the magnesium salt is optimum for controlling the particle diameter. It is also possible to use organic type flocculants such as dimethylaminoethyl (2,2-dimethylol)propionate as the flocculant.

The use amount of the flocculant is 0.5 to 20 parts by weight, preferably 0.5 to 18 parts by weight, and more preferably 1.0 to 18 parts by weight with respect to 100 parts by weight of the toner components. If the use amount of the flocculant is less than 0.5 parts by weight, flocculation does not take place and granulation becomes impossible, and if it is more than 20 parts by weight, the aggregates become too large.

[Explanation of Water]

The water to be used in the washing step in the toner preparation process of the present invention preferably has a conductivity of 20 μS/cm or lower. Conventionally known methods such as an activated carbon method, an ion exchange method, a distillation method and a reverse osmosis method can be used to obtain such water, and these methods may be used alone or in combination of two or more. The temperature of the water at the time of washing is preferably equal to or lower than the lowest glass transition temperature of the glass transition temperatures of the binder resins in terms of prevention of re-flocculation.

[Explanation of Stirrer]

In the aggregate formation step in the toner preparation process of the present invention, it is preferable to use a stirrer for stirring the mixture. Conventionally known emulsifying apparatuses and dispersing apparatuses can be used as the stirrer, and preferable apparatuses are those which can receive the toner components and the aqueous medium in batches or continuously; which have heating means; which are capable of producing a toner in the form of pigment-containing binder resin particles by mixing the toner components and the aqueous medium under heating and; which are capable of discharging the toner in batches or continuously. Also, the emulsifying apparatus and the dispersing apparatus are preferably capable of applying shear force to the mixture of the toner and the aqueous medium since, in such a case, it is easy to make the formed aggregates into particles with uniform particle diameter and shape. Further, the emulsifying apparatus and the dispersing apparatus preferably have at least one of a stirring means and a rotating means and therefore are preferably capable of mixing the toner and the aqueous medium with stirring or rotation. The emulsifying apparatus and the dispersing apparatus preferably have a mixing container for mixing the toner and the aqueous medium together and a heat insulating means for the container.

Specific examples of the emulsifying apparatus and the dispersing apparatus are batch type emulsifying apparatuses such as ULTRA TURRAX (trade name: manufactured by IKA Japan Co., Ltd.), POLYTRON HOMOGENIZER (trade name: manufactured by Kinematica), TK AUTOHOMO-MIXER (trade name: manufactured by Tokushu Kika Kogyo Co., Ltd.), and MAX BLEND (trade name: manufactured by Sumitomo Heavy Industries, Ltd.); continuous type emulsifying apparatuses such as EBARA MILDER (trade name: manufactured by Ebara Corp.), TK PIPELINE HOMO-MIXER (trade name: manufactured by Tokushu Kika Kogyo Co., Ltd.), TK HOMOMIC LINE LOW (trade name: manufactured by Tokushu Kika Kogyo Co., Ltd.), FILMIX (trade name: manufactured by Tokushu Kika Kogyo Co., Ltd.), COLLOID MILL (trade name: manufactured by Shinko Pantec Co., Ltd.), SLASHER (trade name: manufactured by Mitsui-Miike Kakoki Co., Ltd.), TRIGONAL WET FINE PULVERIZER (trade name: manufactured by Mitsui-Miike Kakoki Co., Ltd.), CAVITRON (trade name: manufactured by EUROTEC, LTD.), and FINE FLOW MILL (trade name: manufactured by Pacific Machinery & Engineering Co., Ltd.); CLEAMIX (trade name: manufactured by M. Technique Co., Ltd.) and FILMIX (trade name: manufactured by Tokushu Kika Kogyo Co., Ltd.).

### EXAMPLES

The present invention will be described more in detail with reference to Examples and Comparative Examples. However the present invention should not be construed as being limited to the illustrated embodiments. Modifications and changes in specific process conditions and structures can be made without departing from the spirit and scope of the present invention.

The acid value, the glass transition temperature, and the number average molecular weight of the self-dispersible polyester resin were measured by the following methods.

[Acid Value]

The acid value was measured according to JIS K 0070.

[Glass Transition Temperature]

A peak chart was measured by heating a sample to 200° C. by using a differential scanning calorimeter (trade name: DSC 210, manufactured by Seiko Instruments Inc.), cooling the sample to 0° C. from 200° C. at a cooling rate of 10° C./min, and again heating the sample at a heating rate of 10° C./min and the glass transition temperature was defined as the temperature at the crossing point of the extended base line under the maximum peak temperature and the tangent line showing the maximum slant from the portion where the rise to the peak begins to the apex of the peak.

[Number Average Molecular Weight]

Molecular weight distribution was measured by the following gel permeation chromatograph (GPC) and the number average molecular weight was calculated from the measured molecular weight.

Measurement apparatus: CO-8010 (manufactured by Tosoh Corp.)

Analysis column: GMHLX+G3000HXL (manufactured by Tosoh Corp.)

Sample concentration: 0.5 g/100 mL tetrahydrofuran

Eluent: tetrahydrofuran (40° C.)

Flow speed of eluent: 1 ml/min.

Standard samples: monodispersed polystyrene

[Synthesis of Copolymer Polyester Resins to be Used as Self-Dispersion Type Binder Resins]

(Copolymer Polyester Resin 1)

Terephthalic acid dimethyl ester of 141 parts by weight, isophthalic acid dimethyl ester of 48 parts by weight, ethylene glycol of 41 parts by weight, bisphenol A ethylene oxide adduct (average molecular weight 350) of 245 parts by weight and as a catalyst, tetrabutoxy titanate of 0.1 parts by weight were loaded into an autoclave equipped with a stirrer, a condenser and a thermometer and heated at 150 to 220° C. for 180 minutes to carry out ester-interchange reaction, followed by heating to 240° C. Then, the pressure in the reaction system was gradually decreased to 10 mmHg after 30 minutes and the reaction was continued for 60 minutes. After that, the gas in the autoclave was replaced with nitrogen gas and the pressure was adjusted to atmospheric pressure. The temperature was kept at 200° C. and trimellitic anhydride of 6 parts by weight was added and reaction was carried out for 60 minutes to obtain a copolymer polyester resin 1.

The obtained copolymer polyester resin 1 had a glass transition temperature of 70° C., an acid value of 14 mg KOH/g, and a number average molecular weight of 4000.

(Copolymer Polyester Resin 2)

Telephthalic acid of 199 parts by weight, isophthalic acid of 465 parts by weight, 2,2-dimethyl-1,3-propanediol of 468 parts by weight, 1,5-pentanediol of 156 parts by weight and as a catalyst, tetrabutyl titanate of 0.41 parts by weight were loaded into an autoclave equipped with a stirrer, a condenser and a thermometer and heated at 160 to 230° C. for 4 hours to carry out esterification. Subsequently, the pressure in the reaction system was gradually decreased to 5 mmHg for 20 minutes and further the condensation polymerization reaction was carried out for 40 minutes at 260° C. under vacuum of 0.3 mmHg or lower. Under nitrogen current, the reaction system was cooled to 220° C. and trimellitic anhydride of 23 parts by weight and ethylene glycol bisanhydrotrimellitate of 16 parts by weight were added and reaction was carried out for 30 minutes to obtain a copolymer polyester resin 2. The obtained copolymer polyester resin 2 had a glass transition temperature of 60° C., an acid value of 22 mg KOH/g, and a number average molecular weight of 5800.

(Copolymer Polyester Resin 3)

Terephthalic acid of 109 parts by weight, isophthalic acid of 253 parts by weight, ethylene glycol of 41 parts by weight, 1,4-cyclohexanedimethanol of 94 parts by weight, glycerin of 165 parts by weight and as a catalyst, dibutyltin oxide of 0.14 parts by weight were loaded into an autoclave equipped with a stirrer, a condenser and a thermometer and gradually heated to 220° C. for 3 hours to carry out esterification. The esterification removed a prescribed amount of water. After that, reduced pressure initial polymerization was carried out to reduce the pressure to 10 mmHg for 30 minutes and simultaneously the temperature was raised to 230° C. Subsequently, latter polymerization was carried out for 40 minutes at the same temperature of 230° C. under 1 mmHg or lower, and then the reduced polymerization was halted. Under nitrogen current, the reaction system was cooled to 180° C., and then trimellitic anhydride of 9 parts by weight and phthalic anhydride of 7 parts by weights were added and the mixture was stirred for 30 minutes to obtain a copolymer polyester resin 3. The obtained copolymer polyester resin 3 had a glass transition temperature of 50° C., an acid value of 21 mg KOH/g, and a number average molecular weight of 6000.

(Copolymer Polyester Resin 4)

Telephthalic acid of 142 parts by weight, isophthalic acid of 212 parts by weight, 1,4-butanediol of 72 parts by weight, 1,4-cyclohexanedimethanol of 115 parts by weight, glycerin of 147 parts by weight and as a catalyst, titanium tetrabutoxide of 0.15 parts by weight were loaded into an autoclave equipped with a stirrer, a condenser and a thermometer and gradually heated to 220° C. for 4 hours to carry out esterification. The esterification removed a prescribed amount of water. After that, reduced pressure initial polymerization was carried out to reduce the pressure to 10 mmHg for 30 minutes and simultaneously the temperature was raised to 230° C. Subsequently, latter polymerization was carried out for 50 minutes at the same temperature of 230° C. under 1 mmHg or lower, and then the reduced polymerization was halted. Under nitrogen current, the reaction system was cooled to 160° C., and then trimellitic anhydride of 8 parts by weight and ethylene glycol bistrimellitate dianhydride of 9 parts by weights were added and the mixture was stirred for 30 minutes to obtain a copolymer polyester resin 4. The obtained copolymer polyester resin 4 had a glass transition temperature of 40° C., an acid value of 19 mg KOH/g, and a number average molecular weight of 9800.

(Copolymer Polyester Resin 5)

Dimethyl telephthalic acid of 388 parts by weight, dimethyl isophthalic acid of 388 parts by weight, 2-methyl- 1,3-propanediol of 554 parts by weight, 1,5-pentanediol of 275 parts by weight and tetrabutyl titanate of 0.41 parts by weight were loaded into an autoclave equipped with a stirrer, a condenser, and a thermometer and heated at 160 to 230° C. for 4 hours to carry out ester-interchange reaction. Subsequently, the pressure in the reaction system was gradually decreased to 5 mmHg for 20 minutes and further the condensation polymerization reaction was carried out for 40 minutes at 260° C. under vacuum of 0.3 mmHg or lower. Under nitrogen current, the reaction system was cooled to 220° C. and trimellitic anhydride of 27 parts by weight was added and reaction was carried out for 30 minutes to obtain a copolymer polyester resin 5. The obtained copolymer polyester resin 5 had a glass transition temperature of 30° C., an acid value of 15 mg KOH/g, and a number average molecular weight of 5000.

(Copolymer Polyester Resin 6)

Terephthalic acid of 150 parts by weight, isophthalic acid of 310 parts by weight, adipic acid of 233 parts by weight, ethylene glycol of 155 parts by weight, 2,2-dimethyl-1,3-propanediol of 134 parts by weight, 1,5-pentanediol of 156 parts by weight and as a catalyst, tetrabutyl titanate of 0.4 parts by weight were loaded into an autoclave equipped with a stirrer, a condenser and a thermometer and heated at 160 to 230° C. for 4 hours to carry out esterification. Subsequently, the pressure in the reaction system was gradually decreased to 5 mmHg for 20 minutes and further the condensation polymerization reaction was carried out for 40 minutes at 260° C. under vacuum of 0.3 mmHg or lower. Under nitrogen current, the reaction system was cooled to 220° C. and trimellitic anhydride of 6 parts by weight was added and reaction was carried out for 30 minutes to obtain a copolymer polyester resin 6. The obtained copolymer polyester resin 6 had a glass transition temperature of 20° C., an acid value of 10 mg KOH/g, and a number average molecular weight of 5000.

(Copolymer Polyester Resin 7)

Dimethyl telephthalate of 112 parts by weight, dimethyl isophthalate of 76 parts by weight, 5 sodium sulfodimethyl isophthalate of 6 parts by weight, ethylene glycol of 96 parts by weight, propylene glycol of 50 parts by weight and tetrabutoxy titanate of 0.1 parts by weight were loaded into an autoclave equipped with a thermometer, a condenser and a stirrer, and heated at 180 to 230° C. for 120 minutes to carry out ester-interchange reaction. Subsequently, the temperature in the reaction system was gradually raised to 250° C. and the pressure in the reaction system was adjusted to 1 to 10 mmHg and the reaction was continued for 60 minutes to obtain a copolymer polyester resin 7.

The obtained copolymer polyester resin 7 had a glass transition temperature of 58° C., an acid value of 0.1 KOHmg, and a number average molecular weight of 3100.

Table 1 shows the glass transition temperatures, acid values and number average molecular weights of the obtained copolymer polyester resins 1 to 7. The glass transition temperatures were measured by DSC (differential scanning calorimetry) and the number average molecular weights were measured by GPC (gel permeation chromatography).

[Preparation of Aqueous Copolymer Polyester Resin Dispersions]

(Aqueous Copolymer Polyester Resin Dispersion 1)

The above-mentioned copolymer polyester resin 1 of 100 parts by weight, butanol of 12 parts by weight, methyl ethyl ketone of 48 parts by weight, and isopropanol of 20 parts by weight were loaded into a 10 L four neck separable flask equipped with a thermometer, a condenser and a stirring blade, and stirred at 70° C. for dissolution. Further, an aqueous 1N ammonia solution of 25.2 parts by weight was added to be equivalent to the acid value of the copolymer polyester resin 1 and the resulting solution was stirred at the same temperature of 70° C. for 30 minutes and after that, while the solution was stirred, water at 70° C. of 300 parts by weight was added to obtain a water micro-dispersion of the copolymer polyester resin 1. The obtained water micro-dispersion was loaded into a flask for distillation, and the solid matter was adjusted with deionized water. The water micro-dispersion was heated and the pressure was reduced to obtain a desolvated aqueous copolymer polyester resin dispersion 1 (solid matter concentration: 30%).

(Aqueous Copolymer Polyester Resin Dispersion 2)

The above-mentioned copolymer polyester resin 2 of 100 parts by weight, butyl cellosolve of 20 parts by weight, methyl ethyl ketone of 42 parts by weight, and isopropanol of 20 parts by weight were loaded into a 10 L four neck separable flask equipped with a thermometer, a condenser and a stirring blade, and stirred at 70° C. for dissolution. Further, an aqueous 1N ammonia solution of 39.6 parts by weight was added to be equivalent to the acid value of the copolymer polyester resin 2 and the resulting solution was stirred at the same temperature of 70° C. for 30 minutes and after that, while the solution was stirred, water at 70° C. of 300 parts by weight was added to obtain a water micro-dispersion of the copolymer polyester resin 2. The obtained water micro-dispersion was loaded into a flask for distillation, and the solid matter was adjusted with deionized water. The water micro-dispersion was heated and the pressure was reduced to obtain a desolvated aqueous copolymer polyester resin dispersion 2 (solid matter concentration: 33%).

(Aqueous Copolymer Polyester Resin Dispersions 3 to 7)

The same procedure was followed as in the preparation of the aqueous copolymer polyester resin dispersion 2, except that that the copolymer polyester resins 3 to 7 were used instead of the copolymer polyester resin 2 and that the aqueous 1N ammonium solution was used to be equivalent to the respective acid values of the copolymer polyester resins 3 to 7. Thus, aqueous copolymer polyester resin dispersions 3 to 7 were obtained.

The above-mentioned chemicals in the preparations of the aqueous copolymer polyester resin dispersions 1 to 7 were ones manufactured by Wako Pure Chemical Industries Ltd.

Table 1 shows the average particle diameters of the copolymer polyester resins 1 to 7 in the aqueous copolymer polyester resin dispersions 1 to 7.

TABLE 1

| | Glass transition | | Number average | Average particle |
|---|---|---|---|---|
| | temperature (° C.) | Acid value | molecular weight | diameter (μm) |
| Copolymer polyester | 70 | 14 | 4000 | 0.040 |
| resin 1 | | | | |
| Copolymer polyester | 60 | 22 | 5800 | 0.073 |
| resin 2 | | | | |
| Copolymer polyester | 50 | 21 | 6000 | 0.045 |
| resin 3 | | | | |
| Copolymer polyester | 40 | 19 | 9800 | 0.056 |
| resin 4 | | | | |
| Copolymer polyester | 30 | 15 | 5000 | 0.19 |
| resin 5 | | | | |
| Copolymer polyester | 20 | 10 | 5000 | 0.21 |
| resin 6 | | | | |
| Copolymer polyester | 58 | 0.1 | 3100 | 0.2 |
| resin 7 | | | | |

[Preparation of Aqueous Pigment Dispersions]
(Aqueous Pigment Dispersion 1)

A cyan pigment (Eupolen Blue 69-1501, manufactured by BASF Co., Ltd.) of 50 parts by weight, an anionic surfactant (Neogen R, manufactured by Dai-Ichi Kogyo Seiyaku Co., Ltd.) of 5 parts by weight, and ion-exchanged water of 223 parts by weight were loaded into a homogenizer (PT 3000, manufactured by Polytron Devices Inc.) and stirred at room temperature for 20 minutes to disperse the pigment, and further the dispersing element was dispersed by an ultrasonic homogenizer (manufactured by Nippon Seiki Co., Ltd.) for 20 minutes to obtain an aqueous blue pigment dispersion 1 (average pigment particle diameter: 0.10 μm).

The average particle diameters of the aqueous pigment dispersion 1 and aqueous pigment dispersions 2 to 5 mentioned later were measured by MICROTRACK UPA-ST150, manufactured by Nikkiso Co., Ltd.

(Aqueous Pigment Dispersion 2)

A magenta pigment 1 (Eupolen Red 47-9001, manufactured by BASF Co., Ltd.) of 50 parts by weight, an anionic surfactant (Neogen R, manufactured by Dai-Ichi Kogyo Seiyaku Co., Ltd.) of 5 parts by weight, and ion-exchanged water of 223 parts by weight were loaded into a homogenizer (PT 3000, manufactured by Polytron Devices Inc.) and stirred at room temperature for 20 minutes to disperse the pigment, and further the dispersing element was dispersed by an ultrasonic homogenizer for 20 minutes to obtain an aqueous red pigment dispersion 2 (average pigment particle diameter: 0.09 μm).

(Aqueous Pigment Dispersion 3)

A yellow pigment (Eupolen Yellow 09-6101, manufactured by BASF Co., Ltd.) of 50 parts by weight, an anionic surfactant (Neogen R, manufactured by Dai-Ichi Kogyo Seiyaku Co., Ltd.) of 5 parts by weight, and ion-exchanged water of 223 parts by weight were loaded into a homogenizer (PT 3000, manufactured by Polytron Devices Inc.) and stirred at room temperature for 20 minutes to disperse the pigment, and further the dispersing element was dispersed by an ultrasonic homogenizer for 20 minutes to obtain an aqueous yellow pigment dispersion 3 (average pigment particle diameter: 0.08 μm).

(Aqueous Pigment Dispersion 4)

Carbon black (MOGUL L, manufactured by Cabot Corp.) of 50 parts by weight, a nonionic surfactant (Nonipol 400, manufactured by Sanyo Chemical Industries, Ltd.) of 5 parts by weight, and ion-exchanged water of 223 parts by weight were loaded into a homogenizer (PT 3000, manufactured by Polytron Devices Inc.) and stirred at room temperature for 20 minutes to disperse the pigment and obtain an aqueous carbon black pigment dispersion 4 (average pigment particle diameter: 0.13 μm).

(Aqueous Pigment Dispersion 5)

A magenta pigment 2 (Eupolen Red 47-9001, manufactured by BASF Co., Ltd.) of 50 parts by weight, a cationic surfactant (Sanisol B 50, manufactured by Kao Corp.) of 5 parts by weight, and ion-exchanged water of 223 parts by weight were loaded into a homogenizer (PT 3000, manufactured by Polytron Devices Inc.) and stirred at room temperature for 20 minutes to disperse the pigment, and further the dispersing element was dispersed by an ultrasonic homogenizer for 20 minutes to obtain an aqueous red pigment dispersion 5 (average pigment particle diameter: 0.09 μm).

[Preparation of Aqueous Wax Fine Particle Dispersion]

Paraffin wax (HNP 10, melting point 72° C., manufactured by Nippon Seiro Co., Ltd.) of 50 parts by weight, an anionic surfactant (Neogen R, manufactured by Dai-Ichi Kogyo Seiyaku Co., Ltd.) of 5 parts by weight, and ion-exchanged water of 161 parts by weight were loaded into a stainless beaker equipped with a jacket and were subjected to a homogenizer (PT 3000, manufactured by Polytron Devices Inc.) for 30 minutes while being heated at 95° C. to disperse wax particles, and then transferred to a pressure discharge type homogenizer (manufactured by Nippon Seiki Co., Ltd.) and dispersed at 90° C. for 20 minutes to obtain an aqueous wax fine particle dispersion (average wax particle diameter: 0.4 μm). The average particle diameter of the wax fine particles was measured by MICROTRACK UPA-ST150, manufactured by Nikkiso Co., Ltd.

### EXAMPLE 1

(Mixture Preparation Step)

The aqueous pigment dispersion 2 (containing the pigment magenta 1), the aqueous copolymer polyester resin dispersion 2, and the aqueous wax fine particle dispersion were mixed together at solid matter concentrations (% by weight) in Table 2 to obtain a mixture.

(Aggregate Formation Step)

While the obtained mixture was stirred at 500 rpm by a Max Blend stirrer, an aqueous solution of 0.1% by weight of magnesium chloride as a flocculant was dropwise added to the mixture in a 30 parts by weight to 100 parts by weight of polyester resin solid matter weight ratio and after that, the mixture was stirred for 1 hour. Accordingly, aggregates of a toner were formed in the water medium. Next, the aqueous copolymer polyester resin dispersion 1 was added at a solid matter concentration (% by weight) in Table 2 and an aqueous solution of 0.02% by weight of magnesium chloride was dropwise added in a 150 parts by weight to 100 parts by weight of polyester resin solid matter weight ratio and after that, the mixture was stirred for 1 hour. Accordingly, aggregates of a toner were further formed in the water medium.

(Particle Formation Step)

The water medium containing the aggregates formed in the aggregate formation step was heated to 75° C. and stirred for 60 minutes and further stirred at 94° C. for 20 minutes to make the particle diameter and shape of the aggregates uniform. At that time, in order to prevent re-flocculation, Neogen SC-F (manufactured by Dai-Ichi Kogyo Seiyaku Co., Ltd.) was added at an amount of 0.07% by weight with respect to the mixture.

(Washing Step)

Next, the supernatant solution was removed from the water medium having the aggregates settled therein and the aggregates were washed with water three times (supernatant solution was replaced three times) and subsequently washed once with an aqueous HCl solution having a pH adjusted to 2 and further washed with water three times. The resulting aggregates were filtered and dried by a vacuum drying apparatus to obtain a magenta toner. The polyester resin aggregates (toner) obtained has an average particle diameter of 6.5 μm.

The water to be used for washing was water having a conductivity of 0.5 μS/cm and produced from tap water by using an ultrapure water preparation apparatus (Ultra Pure Water System CPW-102, manufactured by ADVANTEC). The pH and conductivity of the water were measured by la comme tester (EC-PHCON 10, manufactured by IUCHISEIEIDO).

After that, 0.7 parts by weight of silica treated with a silane coupling agent and having an average primary particle diameter of 20 nm was added (extrapolated) to 100 parts by weight of the magenta toner. Thus, a magenta toner of Example 1 was obtained.

Further, the magenta toner of Example 1 and a carrier made of manganese-type ferrite having an average particle diameter of 55 μm coated with a silicon resin and with an additive were mixed together so that the magenta toner contained in the mixture was 6% by weight with respect to the carrier. Thus, a developer of Example 1 was obtained. Developers of Examples 2-4 and Comparative Examples 1-6 were prepared substantially in the same manner as in Example 1.

### EXAMPLE 2

The same procedure as in Example 1 was followed except that the aqueous pigment dispersion 1 containing the pigment cyan and the aqueous copolymer polyester resin dispersion 3 at respective solid matter concentrations (% by weight) in Table 2 were used instead of the aqueous pigment dispersion 2 containing the pigment magenta 1 and the aqueous copolymer polyester resin dispersion 2 and that the aqueous HCl solution used in the washing step was adjusted to pH 3 instead of pH 2 and the aggregates of the toner were washed with this aqueous HCl solution twice instead of once. Thus, a cyan toner of Example 2 was obtained.

### EXAMPLE 3

The same procedure as in Example 1 was followed except that the aqueous pigment dispersion 3 containing the pigment yellow and the aqueous copolymer polyester resin dispersion 4 at respective solid matter concentrations (% by weight) in Table 2 were used instead of the aqueous pigment dispersion 2 containing the pigment magenta 1 and the aqueous copolymer polyester resin dispersion 2 and that respective solid matter concentrations (% by weight) of the aqueous copolymer polyester resin dispersion 1 was changed as shown in Table 2. Thus, a yellow toner of Example 3 was obtained.

### EXAMPLE 4

The same procedure as in Example 1 was followed except that the aqueous pigment dispersion 4 containing the pigment black and the aqueous copolymer polyester resin dispersion 4 at respective solid matter concentrations (% by weight) in Table 2 were used instead of the aqueous pigment dispersion 2 containing the pigment magenta 1 and the aqueous copolymer polyester resin dispersion 2 and that in the aggregate formation step, the aqueous copolymer polyester resin dispersion 2 at a solid matter concentration (% by weight) in Table 2 was added instead of the aqueous copolymer polyester resin dispersion 1. Thus, a black toner of Example 4 was obtained.

### COMPARATIVE EXAMPLE 1

The same procedure as in Example 1 was followed except that the aqueous pigment dispersion 1 containing the pigment cyan and the aqueous copolymer polyester resin dispersion 5 at respective solid matter concentrations (% by weight) in Table 2 were used instead of the aqueous pigment dispersion 2 containing the pigment magenta 1 and the aqueous copolymer polyester resin dispersion 2. Thus, a cyan toner of Comparative Example 1 was obtained.

### COMPARATIVE EXAMPLE 2

The same procedure as in Example 1 was followed except that the aqueous pigment dispersion 3 containing the pigment yellow and the aqueous copolymer polyester resin dispersion 6 at respective solid matter concentrations (% by weight) in Table 2 were used instead of the aqueous pigment dispersion 2 containing the pigment magenta 1 and the aqueous copolymer polyester resin dispersion 2. Thus, a yellow toner of Comparative Example 2 was obtained.

### COMPARATIVE EXAMPLE 3

The same procedure as in Example 1 was followed except that the aqueous pigment dispersion 5 containing both the pigment magenta 2 and the cationic surfactant was used instead of the aqueous pigment dispersion 2 containing the pigment magenta 1. Agglomerates were formed in the mixture preparation step, and no toner was obtained.

### COMPARATIVE EXAMPLE 4

The same procedure as in Example 1 was followed except that the washing with the aqueous HCl solution having a pH of 2 was not carried out. Thus, a toner of Comparative Example 4 was obtained.

### COMPARATIVE EXAMPLE 5

The same procedure as in Example 1 was followed except that the aqueous pigment dispersion 1 containing the pigment cyan and the aqueous copolymer polyester resin dispersion 3 at a solid matter concentration (% by weight) in Table 2 was used instead of the aqueous pigment dispersion 2 containing the pigment magenta 1 and the aqueous copolymer polyester resin dispersion 2 and that as the flocculant, a cationic surfactant Sanisol B was used instead of magnesium chloride. Thus, a toner of Comparative Example 5 was obtained.

### COMPARATIVE EXAMPLE 6

The same procedure as in Example 1 was followed except that the aqueous copolymer polyester resin dispersions 4 and 7 and the aqueous pigment dispersion 3 at respective solid matter concentrations (% by weight) in Table 2 were used instead of the aqueous copolymer polyester resin dispersions 1 and 2 and the aqueous pigment dispersion 2. Thus, a toner of Comparative Example 6 was obtained.

TABLE 2

| | | | | | | Co. | Co. | Co. | Co. | Co. | Co. |
|---|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex. 5 | Ex. 6 |
| Self-dispersion | Co. polyester resin 1 | 30 | 30 | 40 | | 30 | 30 | 30 | 30 | 30 | |
| type binder resin | Co. polyester resin 2 | 60 | | | 55 | | | 60 | 60 | | |
| | Co. polyester resin 3 | | 60 | | | | | | | 60 | |
| | Co. polyester resin 4 | | | 50 | 32 | | | | | | 50 |
| | Co. polyester resin 5 | | | | | 60 | | | | | |
| | Co. polyester resin 6 | | | | | | 60 | | | | |
| | Co. polyester resin 7 | | | | | | | | | | 40 |
| Pigment | Cyan (aqueous | | 5 | | | | | | | 5 | |
| | pigment dispersion 1) | | | | | | | | | | |
| | Magenta 1 (aqueous | 5 | | | | 5 | | | 5 | | |
| | pigment dispersion 2) | | | | | | | | | | |
| | Yellow (aqueous | | | 5 | | | 5 | | | | 5 |
| | pigment dispersion 3) | | | | | | | | | | |
| | Black (aqueous | | | | 8 | | | | | | |
| | pigment dispersion 4) | | | | | | | | | | |
| | Magenta 2 (aqueous | | | | | | | 5 | | | |
| | pigment dispersion 5) | | | | | | | | | | |

| | | | | | | | | | | |
|---|---|---|---|---|---|---|---|---|---|---|
| Wax | 5 | 5 | 5 | 5 | 5 | 5 | 5 | 5 | 5 | 5 |

Co. polyester resin: Copolymer polyester resin
Ex.: Example
Co. Ex.: Comparative Example

[Evaluation Method]

The respective evaluations of average particle diameter, variable coefficient, average roundness, image density, fogging, environmental property, fixation property and storability as well as a collective evaluation of these items were carried out for the toners of Examples 1 to 4 and Comparative Examples 1-6 according to the following evaluation methods. The results are shown in Table 3. In Table 3 and in the following descriptions, the symbol ◯ indicates that the toner is excellent and the symbol × indicate that the toner is inadequate in practical application.

(Average Particle Diameter and Variable Coefficient)

The average particle diameters and the variable coefficients of the toners were measured by Coulter Multicizer II (manufactured by Coulter Inc.), and the toners were evaluated according to the following standard on the basis of the variable coefficients. The number of the measured particles was 50,000 count and the aperture diameter was 100 μm. The unit of the average particle diameter in Table 3 is μm.
α: variable coefficient was lower than 40
×: variable coefficient was 40 or higher
   (Average Roundness)

The average roundness of the toner particles was measured by using a flow type particle image analyzer (FPIA-2000, manufactured by Toa Iyo Denshi Co., Ltd.). The average roundness is defined by the following expression using projected images of particles detected by the flow type particle image analyzer and has a value of 1 or lower. Average roundness=(circumferential length of a circle having the same surface area as that of the projected image)/(circumferential length of the projected image)

(Image Density)

The image density was evaluated according to the following standard based on the optical density of an evaluation image measured by a spectrophotometric colorimeter (X-Rite 938, manufactured by Nippon Lithograph, Inc). Each evaluation image was produced by carrying out printing using each of the above-mentioned developers and a modified development apparatus of a digital full color copying machine (AR-C 280, manufactured by Sharp Corp.) while controlling the deposition amount of toner particles to be 0.6 mg/cm² on paper exclusive for full color printing (PP106A4C, manufactured by Sharp Corp.) and using an external fixing apparatus.
◯: optical density was 1.2 or higher
×: optical density was lower than 1.2
   (Fogging)

The fogging was evaluated as follows. In the case of black color toners, the whiteness of paper exclusive for full color printing (PP106A4C, manufactured by Sharp Corp.) with a size of A4 was measured by a whiteness meter (Z-Σ90 COLOR MEASURING SYSTEM, manufactured by Nippon Denshoku Kogyo Co., Ltd.) and the measured value was defined as a first measured value W1. Next, 3 copies of a document having depicted thereon a white circle with a diameter of 55 mm were obtained by copying and the whiteness of the white parts of the copies was measured and the measured value was defined as a second measured value W2. The fogging density W (%) was calculated from the following equation and the fogging was evaluated according to the following standard on the basis of the calculated fogging density.
W={100×(W1−W2)/W1}
◯: fogging density W was 2.0% or lower
×: fogging density W was higher than 2.0%
   (Environmental Evaluation)

70 g of each of the above-mentioned toners was loaded into a developing tank and the electric charge quantity of the toner was measured by rotating the developing tank under environment conditions (a) and (b) ((a) 5° C. temperature and 10% humidity; (b) 35° C. temperature and 80% humidity) at the same rotation speed as the above-mentioned image formation apparatus, and the evaluation was carried out according to the following standard based on the relative ratio of the electric charge quantity of the toner under the high temperature and high humidity environment conditions (b) to the electric charge quantity of the toner under the low temperature and low humidity environment conditions (a).
◯: alteration ratio was 60% or lower
×: alteration ratio was higher than 60%
   (Fixation Property)

The fixation property was evaluated by fixing each toner on paper on which a specific chart was copied by an external fixing apparatus and determining the temperature range from the temperature at which the cold off-set occurred to the temperature at which the hot off-set occurred and the evaluation was carried out based on the case where the non-off-set region is following region.
◯: the non-off-set region is 50° C. or higher
×: the non-off-set region is lower than 50° C.
   (Storability)

Evaluation of the storability was carried out as follows. Each toner 100 g was weighed in a sample bottle and then stored at 45° C. for 24 hours. The stored sample was sifted through a sieve having a sieve opening of about 100 μm. In the case where agglomerates were observed, the toner was evaluated as × and in the case where no agglomerates were observed, it was evaluated as ◯.

TABLE 3

| | Average | | | | | | | | | | | | | |
|---|---|---|---|---|---|---|---|---|---|---|---|---|---|---|
| | particle | Variable | | Average | Image | | | | Environmental | | Fixation | | | Collective |
| | diameter | coefficient | | roundness | density | | Fogging | | evaluation | | property | | Storability | evaluation |
| Ex. 1 | 6.5 | 25 | ◯ | 0.97 | 1.3 | ◯ | 0.9 | ◯ | 69 | ◯ | 60 | ◯ | ◯ | ◯ |
| Ex. 2 | 7.0 | 25 | ◯ | 0.97 | 1.2 | ◯ | 0.8 | ◯ | 69 | ◯ | 60 | ◯ | ◯ | ◯ |
| Ex. 3 | 6.2 | 22 | ◯ | 0.97 | 1.3 | ◯ | 0.8 | ◯ | 70 | ◯ | 55 | ◯ | ◯ | ◯ |
| Ex. 4 | 6.1 | 23 | ◯ | 0.97 | 1.9 | ◯ | 0.9 | ◯ | 70 | ◯ | 55 | ◯ | ◯ | ◯ |
| Co. Ex. 1 | 7.6 | 26 | ◯ | 0.97 | 1.3 | ◯ | 0.9 | ◯ | 55 | X | 40 | X | X | X |
| Co. Ex. 2 | 12.0 | 40 | X | 0.96 | 1.2 | ◯ | 0.9 | ◯ | 65 | ◯ | 35 | X | X | X |
| Co. Ex. 3 | 45.0 | 100 | X | — | — | X | — | X | — | X | — | — | X | X |
| Co. Ex. 4 | 6.5 | 25 | ◯ | 0.97 | 1.1 | ◯ | 1.1 | ◯ | 45 | X | 60 | ◯ | ◯ | X |
| Co. Ex. 5 | 55 | 80 | X | — | — | X | — | X | — | X | — | — | X | X |
| Co. Ex. 6 | 6.8 | 26 | ◯ | 0.97 | 1.2 | ◯ | 1.1 | ◯ | 30 | X | 60 | ◯ | ◯ | X |

Mark (−) in Table 3 indicates that the measurement was not able to be made.

Table 3 shows that the toners of Examples 1 to 4 produced by the toner preparation process of the present invention were excellent in toner properties such as particle diameter distribution, image density, fogging, environmental property, fixation property and storability. The toner of Example 4 had no problem with storability despite that the glass transition temperatures of the copolymer polyester resins used were above the temperature at which the evaluation of storability was carried out. This is a merit of using at least two copolymer polyester resins.

On the other hand, the toners of Comparative Examples 1 and 2, prepared using the copolymer polyester resins having a glass transition temperature of lower than 40° C., were inferior in fixation properties and storability. The toner of Comparative Example 2, prepared using the copolymer polyester resins having an average particle diameter of 0.2 μm or more, failed to have a desired average particle diameter and variable coefficient. Also, it was found that where a aqueous pigment dispersion containing a cationic dispersant is used as in Comparative Example 3, no toner is obtained. The toner of Comparative Example 4 was poor in environmental property since the aggregates of the toner were not washed with acid water having a pH of 6 or lower in the washing step. The toners of Example 2 and Comparative Example 5, prepared with no use of a polyvalent metal salt as a flocculant, were hardly controlled in particle diameter. The toner of Comparative Example 6, prepared using a sulfonate polyester as a functional group of the polyester resin, was poor in environmental property.

1. A process for preparing a toner for electrostatic image development, the process comprising the steps of:
(S1) mixing an aqueous pigment dispersion with an aqueous resin particle dispersion containing two or more kinds of self-dispersible polyester resin particles as binder resins to prepare a mixture; and
(S2) adding a polyvalent metal salt as a flocculant to the mixture while stirring to form aggregates having the pigment bonded to the resin particles,
wherein the self-dispersible polyester resins each are prepared by reacting a carboxylic acid compound with an alcohol compound inclusive of a polyhydric alcohol, and the carboxylic acid compound includes one or more kinds of a polycarboxylic acid having three or more carboxyl groups and its acid anhydride, the self-dispersible polyester resin particles are made from two or more kinds of self-dispersible polyesters having different glass transition temperatures, of which the lowest glass transition temperature is not lower than 40 ° C.

2. The process according to claim 1, wherein the step (S2) further comprises adding the aqueous resin particle dispersion containing self-dispersible polyester resin particles with the mixture containing the aggregates while stirring.

3. The process according to claim 1, wherein the toner has an average particle diameter of 10 μm or smaller.

4. The process according to claim 1, wherein the self-dispersible polyester resin perticles have an average particle diameter of 0.2 μm or smaller.

5. The process according to claim 1, wherein the polyvalent metal salt is a magnesium salt or aluminum salt.

6. The process according to claim 1, further comprising the step of washing the aggregates with water and drying the aggregates after the step (S2).

7. The process according to claim 6, wherein the washing step includes washing the aggregates one or more time with water having a pH of 6 or lower.

8. The process according to claim 1, wherein the aqueous pigment dispersion contains a dispersant containing at least one of an anionic surfactant and a nonionic surfactant.

9. The process according to claim 1, further comprising the step of heating the mixture containing the aggregates to uniformize the aggregates in particle diameter and shape after the step (S2).

10. The process according to claim 1, wherein the step (S1) further comprises adding an aqueous wax fine particle dispersion containing at least one of natural and synthesized wax fine particles to be bonded with the resin particles.

11. The process according to claim 1, wherein the flocculant is added to the mixture while stirring by mechanical shear force in the step (S2).

12. A toner for electrostatic image development prepared by the process according to claim 1.

13. The toner according to claim 12, further comprising one or more kinds of inorganic particles adhered to toner particle surfaces, the inorganic particles having an average particle diameter of 1 μm or smaller.

14. An electrostatic image developer containing (1) the toner according to claim 12 and (2) a carrier.

15. An image formation method comprising the steps of:
forming an electrostatic latent image on a photoconductor;
forming a toner image by developing the electrostatic latent image on the photoconductor using the electrostatic image developer according to claim 14; and
transferring and fixing the toner image onto a recording medium.

16. An image formed by the image formation method according to claim 15.
